(19) United States
(12) Patent Application Publication
(10) Pub. No.: US 2012/0221609 A1
(43) Pub. Date: Aug. 30, 2012

(54) Data Storage System and Method

(76) Inventors: Jaap-Jan Boor, Huizen (NL); Ard Biesheuvel, Amsterdam (NL)

(21) Appl. No.: 13/383,260

(22) PCT Filed: Jul. 10, 2009
(86) PCT No.: PCT/EP2009/058823

§ 371 Date: May 15, 2012

(51) Int. Cl. G06F 17/30

(52) U.S. Cl. 707/822; 707/E17.01

(57) ABSTRACT

A data storage system comprises: a data storage device (2) that stores a file system (4), wherein the file system (4) comprises metadata that maps file identifiers of files in the file system (4) to physical storage elements that store the files; file system mapping means (94) for reading the metadata of the file system (4) to determine physical storage elements that store a predetermined at least one file (8) of the file system (4), and storing identification data that identifies the determined physical storage elements; and reading and/or writing means (92, 96) that is configured in operation to read the stored identification data and read from and/or write to physical storage elements (84-89) identified by the identification data.

The present invention relates to a data storage system and method, and in particular to a system and method comprising or relating to mass data storage devices.

### BACKGROUND TO THE INVENTION

Almost all electronic devices require memory for data storage. Flash memory devices for instance have become increasingly commonly used either as permanently installed internal data storage devices or as removable data storage devices, for example memory cards.

A variety of file systems are available for storing and accessing files on memory devices. Different file systems have different characteristics and some are more suited for particular purposes or file types than others. Many embedded devices containing memory rely on standard file systems, for example File Allocation Table (FAT) file systems, in order to facilitate data exchange with a PC. Many highly optimized file systems exist for embedded devices but they cannot be read or written by a standard PC directly and therefore are often not used despite their greater suitability for operation of the embedded devices.

It is known to include more than one file system on the same device, and more than one file system may be mounted at the same time. For example, it is known to embed a second file system of a second type within a first file system of a first type by storing the file system of the second type as a loopback file in the file system of the first type. The loopback file can be referred to as a file system within a file. In operation, a loop device included, for example, in an operating system is used to mount the loopback file as a block device and the file system included in the loopback file can be accessed via the usual file system interface of the operating system.

In certain circumstances the use of combinations of file systems, particularly in loopback arrangements, can lead to the loss of certain functionality (for example, correct journaling) of one or other of the file systems or to unreliable operation of the file systems. For example, reads and writes to a second file system, included in a loopback file, generally have to pass through the first file system. The ordering of physical operations on the data storage device is determined by the file system driver for the first file system, and may be incompatible with the ordering intended by the second file system. For example, if a journaled file system were to be included in a loopback file, then the ordering of journal operations on the physical device may be inconsistent with that required by the journaled file system, destroying the integrity of the journal.

Furthermore, the writing of data of the file system included in the loopback file to the physical device may require duplication in the page cache of the data to be written, with the data being written to the page cache by the second file system included in the loopback file and then copied within the page cache by the first file system, before being written to the physical device, leading to inefficient use of memory resources and possible errors.

Turning to the characteristics of particular file systems, File Allocation Table (FAT) based file systems are commonly used for both embedded and removable data storage devices. FAT systems are particularly useful for removable data storage devices as they are supported by most operating systems used in personal computers, and thus present few interoperability or compatibility issues.

A FAT file system stores a file allocation table on the data storage device, which identifies where each file is stored at the hardware level of the data storage device, by mapping hardware level elements, referred to as clusters or blocks, to each stored file. The file allocation table also stores other information concerning the stored files, the file system, and the hardware level structure, in the form of metadata.

However, earlier versions of FAT file systems cannot cope with long file names, and those later versions that can cope with long file names do so in a relatively inefficient manner.

In addition, if power failures occur then FAT systems are not safe. The relationship between file contents and file metadata, as well as the internal consistency of the file system may be damaged by a power failure, for example if the power failure occurs during a write operation.

Some electronic devices monitor power levels and ensure a safe shutdown if power is close to being exhausted. However, even in the case of such devices, problems can occur if a removable data storage device is forcibly removed during a read or write operation, or if power failure occurs due to an unforeseen device or component failure.

Power failure problems can be particularly acute in an automotive environment, as power is often delivered by the vehicle battery to electronic devices associated with the vehicle. Examples of such electronic devices in an automotive environment include navigation devices, for example portable navigation devices (PNDs). The software, or other control system, of such electronic devices may have little or no control over the level of power delivered. For example, during an engine start, power can drop to dangerously low levels especially if the vehicle battery is old. That may cause corruption of data if a non-power fail safe file system, such as FAT, is used.

More generally, power failure problems can occur if an SD card, or any other removable memory device, is removed from a device or computer, for example a PC, whilst the SD card or memory device is being written to.

Some known file systems, for example Ext3, provide power fail safe journaling capabilities in which data to be stored by the file system is copied temporarily to a journal before being written to the location assigned by the file system. If a power failure occurs during a write procedure, a copy of data that is in the process of being written should be retained in the journal, and can be used to restore the correct data to the location assigned by the file system. Furthermore, some such known file systems, again for example Ext3, can deal with long file names in an efficient manner.

However, such file known file systems are less prevalent than file systems such as FAT, and can present significant compatibility and interoperability issues. That can present particular problems in the case of removable data storage devices, which may be required to be compatible with a wide variety of electronic devices or operating systems.

It is an aim of the present invention to provide an improved, or at least alternative, data storage system.

### SUMMARY OF THE INVENTION

In a first independent aspect of the invention there is provided a data storage system comprising:—a data storage device that stores a file system, wherein the file system comprises metadata that maps file identifiers of files in the file system to physical storage elements that store the files; file system mapping means for reading metadata of the file system, to determine physical storage elements that store a predetermined at least one file of the file system, and storing identification data that identifies the determined physical storage elements; and reading and/or writing means that is configured in operation to read the stored identification data and read from and/or write to physical storage elements identified by the identification data.

Thus, the reading and/or writing means may read from and/or write to physical storage elements that store content of the predetermined at least one file without having to read or write metadata of the first file system. Thus, the first file system may be less likely to be harmed by the reading or writing, either intentionally or unintentionally. The file identifiers may comprise file names. The reading and/or writing means may comprise at least one of a driver and a file system interface.

The predetermined at least one file may comprise at least one plain file. Thus, selective access to the content of the predetermined may be obtained without requiring access to first file system metadata.

The physical storage elements identified by the identification data may exclude substantially all elements that include metadata of the file system.

The file system may be a first file system of a first type, and the predetermined at least one file may comprise a second file system of a second, different type. Thus, a combination of file systems having different desired characteristics may be provided.

The identification data may comprise a mapping between logical elements of the second file system and corresponding physical storage elements. By providing a mapping that can be used to map logical elements of the second file system to physical storage elements of the second file system, selective access to files or parts of files stored in the second file system may be obtained, despite the second file system being embedded as a file or files within the first file system.

Furthermore, by providing the mapping, a second file system can be included in a first file system without necessarily requiring the use of a loop driver. In turn, the additional memory overheads and inefficiencies associated with the need to copy data between memory areas, for example within volatile memory, that is usually needed for correct operation of a loop driver may be avoided. Furthermore, by mapping directly between logical elements of the second file system and physical storage elements proper operation of journaling or other file system reliability features may be enabled.

The mapping means may be configured to store the mapping for subsequent use by other components of the system. Thus, the mapping means may only need to be operated once each time the system is operational, for example on system boot-up.

A physical storage element may comprise, for example, a block or a cluster. A logical element may be a unit of data. A logical element may be a unit of data used by a file system interface or driver to transfer data to or from the or a data storage device. Each logical element may comprise the data, or a portion of the data, of a file. A logical element may comprise, for example, a block.

The mapping may comprise a mapping between logical elements of the second file system and physical storage elements of the data storage device.

As mentioned above, the at least one file may comprise at least one plain file stored in the first file system. By using a plain file or plain files to store the second file system, selective access to files or parts of files stored within the second file system may be obtained without requiring access to first file system metadata. Furthermore, the second file system may be stored across multiple plain files in a simple manner. As the second file system can span multiple plain files, the size of the second file system may not be limited by file size limits on files of the first file system.

The physical storage elements mapped by the mapping means may exclude substantially all elements that include first file system metadata. By excluding substantially all elements that include first file system metadata, access to the second file system may be obtained without interfering with the first file system, or whilst keeping interference with operation of the first file system to a minimum.

The system may further comprise translation means for determining at least one physical storage element of the data storage device that corresponds to a selected at least one logical element of the second file system, using the mapping determined by the mapping means.

Thus, access to individual physical storage elements that correspond to selected logical elements may be obtained without necessarily accessing physical storage elements that correspond to other, non-selected logical elements.

The reading and/or writing means may comprise a file system interface for the second file system, operable to identify at least one, or each, logical element of a selected file of the second file system, and to determine the at least one physical storage element that corresponds to the identified at least one logical element using the mapping. The file system interface may be arranged to receive a request to perform an operation on the selected file of the second file system, and to perform the operation on the determined, corresponding at least one physical storage element.

Thus, operations on selected files of the second file system may be performed without having to perform operations on other files of the second file system and/or without having to perform operations on the at least one file of the first file system that comprises the second file system. The file system interface may comprise the translation means, and/or may use the translation means to determine the at least one physical storage element.

The operation may comprise a write operation or a read operation, and the file system interface may be operable to perform the write operation or the read operation on the determined, corresponding at least one physical storage element of the selected file without performing a read or write operation on at least one physical storage element of at least one other file of the second file system.

The system may comprise a file system interface for the first file system, and the file system interface for the second file system may be arranged to perform the operation on the at least one physical storage element independently of the file system interface for the first file system. Thus, correct operation of the second file system may not be interfered with by the first file system.

The file system interface for the second file system may be arranged to perform the operation on the at least one physical storage element without sending a request to perform the operation to the file system interface for the first file system.

The file system interface for the second file system may be arranged to perform the operation without opening the at least one file of the first file system that comprises the second file system. The operation may be performed without opening the at least one file of the first file system using the file system interface for the first file system.

The performance of the operation on the determined, corresponding at least one physical storage element of the data storage device may comprise substantially no alteration to first file system metadata. Thus, correct operation of the first file system may be obtained, despite operations being performed on the second file system that is included in the first file system. Operations on the second file system may not affect subsequent operations on the first file system.

As there may be substantially no alteration to first file system metadata, even for write operations to the second file system, it may not be necessary to mount the first file system in order to perform operations on the second file system. The second file system may be mountable for reading and writing operations, whilst mounting the first file system read only, or not mounting the first file system.

The performance of the operation by the file system interface may comprise writing a succession of logical elements to corresponding physical storage elements, and the file system interface may be configured to write at least some of the succession of logical elements to corresponding physical storage elements in a desired order.

The file system interface may comprise a cache. The file system interface may further comprise a device driver for performing operations on physical storage elements of the data storage device.

The performance of the operation may comprise writing the succession of logical elements to a cache, and writing the logical elements from the cache to the corresponding physical storage elements, and the file system interface may be configured to write at least some of the logical elements from the cache to the corresponding physical storage elements in the same, desired order as they were written to the cache.

The logical elements that are written in a desired order may comprise journal data or journal metadata.

The performance of an operation on a logical element may comprise writing the logical element to a page cache, and the performance of a corresponding operation on at least one physical storage element may comprise writing the logical element from the page cache to the at least one physical storage element.

The selected file may comprise a boot file, and the operation may comprise reading the boot file from the second file system. Thus, the system may be booted from the second file system rather than the first file system.

The second file system may be mounted as a root file system. The file system interface may be configured to mount the second file system as a root file system.

The first file system may comprise a non-power-fail-safe file system and the second file system may comprise a power-fail-safe file system.

The second file system may comprise a journaled or a transactional file system and the first file system may comprise a non-journaled or non-transactional file system.

The system may further comprise a file system controller for directing file system operations to one or other of the first and second file systems.

The file system controller may be arranged to receive requests to write files to the first or second file systems, and to write to the second file system in response to substantially all requests to write files that have at least one predetermined file name property to the first or second file system. Thus, a combination of file systems having desired characteristics can be provided whilst avoiding problems with the use of file names having one or more predetermined properties in one of the file systems. The system may be particularly useful in the case where the first file system has desired characteristics (for example, a desired level of compatibility with other systems) but does not support long file names or supports such file names less efficiently than the first file system.

The at least one predetermined file name property may comprise the property that the file name is not supported by the first file system.

The at least one predetermined file name property may comprise the property that the file name is longer than a predetermined file name length limit.

The file name may comprise a main part and an extension part. The predetermined length limit may comprise a predetermined number of characters of at least one of the file name, a main part of the file name, or an extension part of the file name. The predetermined length limit may comprise at least one of 8 characters for the main part of a file name, 3 characters for an extension part of a file name, and 11 characters for a file name.

The predetermined length limit may be less than the maximum length that can be supported by the first file system. That feature can be particularly useful if the first file system is able to support file names longer than the limit but supports them less efficiently or reliably than file names of length equal to or less than the limit. That feature can also be useful if the first file system can support file names longer than the limit, but requires a modification, configuration or setting in order to do so. By directing write operations longer than the limit to the second file system, the modification, configuration or setting of the first file system may not have to be implemented in the system.

The file system controller may be configured to write to the second file system in response to substantially all requests received by the file system controller for write operations to the first or second file systems. The file system controller may be configured to redirect write operations intended for the first file system to the second file system.

The first file system may comprise a FAT-based file system and the second file system may comprise an EXT file system. The FAT-based file system may comprise one of an FAT, vFAT, FAT16, or FAT32 file system. The second file system may comprise an Ext3 file system or a successor to the Ext3 file system.

Alternatively or additionally, the predetermined at least one file may comprise a database, database entries for a database or a pagefile.

The data storage system may be for storing data for use by an electronic device. The electronic device may comprise, for example, at least one of a navigation device, an MP3 player or other music player, a digital camera, a video camera, a personal digital assistant (PDA), a mobile phone, a laptop or handheld computer or any kind of embedded device or processor.

In another independent aspect of the invention there is provided a data storage device storing a first file system of a first type, wherein at least one plain file stored in the first file system comprises a second file system of a second, different type.

The file systems may comprise a plurality of files, and the plurality of files may be partitioned between the first file system and the second file system such that substantially all file names longer than a predetermined length limit are stored on the second file system.

The predetermined length limit may be less than a maximum file name length supported by the first file system.

In a further independent aspect of the invention there is provided a method of reading and/or writing data comprising reading metadata of a file system that is stored on a data storage device to determine physical storage elements of the data storage device that store a predetermined at least one file of the file system, storing identification data that identifies the determined physical storage elements, reading the stored identification data and reading and/or writing data to physical storage elements identified by the identification data.

In another independent aspect there is provided a data storage system comprising:—a data storage device that stores a file system, wherein the file system comprises metadata that maps file identifiers of files in the file system to physical storage elements that store the files; a file system mapping device for reading the metadata of the file system to determine physical storage elements that store a predetermined at least one file of the file system, and storing identification data that identifies the determined physical storage elements; and

A reading and/or writing device that is configured in operation to read the stored identification data and read from and/or write to physical storage elements identified by the identification data.

In another independent aspect of the invention there is provided a computer program product comprising computer executable instructions for performing a method as claimed or described herein.

In a further independent aspect of the invention there is provided a computer program product comprising computer executable instructions for providing file system mapping means for reading metadata of a file system that is stored on a data storage device to determine physical storage elements of the data storage device that store a predetermined at least one file of the file system, and storing identification data that identifies the determined physical storage elements.

Any feature in one aspect of the invention may be applied to other aspects of the invention, in any appropriate combination. For example, system features may be applied to method or computer program product features and vice versa.

### BRIEF DESCRIPTION OF THE DRAWINGS

At least one embodiment of the invention will now be described, by way of example only, with reference to the accompanying drawings, in which:

FIG. 1 is a schematic illustration of a data storage device according to one embodiment;

FIG. 2 is a schematic illustration of a navigation device;

FIG. 3 is schematic representation of an architectural stack of the navigation device of FIG. 2;

FIG. 4a is a schematic illustration of the data structure of the data storage device;

FIG. 4b is a schematic illustration of the structure of an Ext3 file system included in the data storage device;

FIGS. 5a is a schematic illustration showing logical elements of a file of the second file system and corresponding physical storage elements;

FIG. 5b is a schematic illustration showing logical elements of the plain file that contains the second file system, and corresponding physical storage elements;

FIG. 6 is a schematic illustration of the installation of the data storage device of FIG. 1 in the navigation device of FIG. 2;

FIG. 7 is a flowchart illustrating in overview a read operation and subsequent write operation; and

FIG. 8 is a schematic illustration of the data storage device in communication with a personal computer.

### DETAILED DESCRIPTION OF EMBODIMENTS

Embodiments of the present invention will now be described, by way of example only. The described embodiments relate to data storage devices, and file system arrangements in such data storage devices.

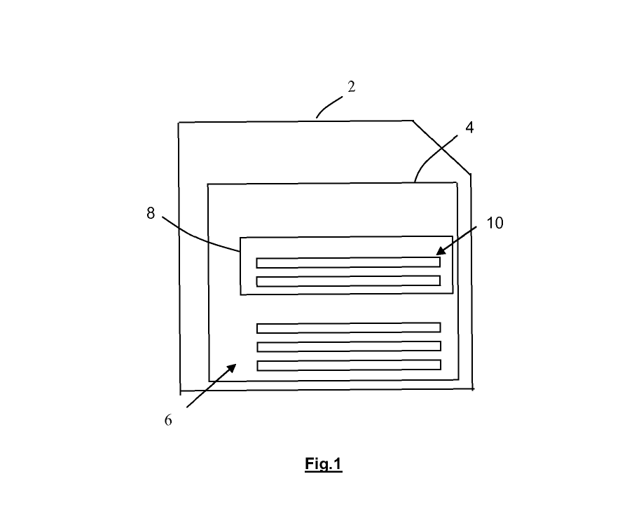

A data storage device 2 according to a first embodiment is illustrated in FIG. 1. The data storage device 2 is in the form of an SD card comprising a FAT-file system 4 in which can be stored a plurality of data and other files 6. A further file 8 is stored in the FAT file system 4, which comprises an Ext3 file system, which in turn comprises a plurality of data and/or other files 10, as described in more detail below. In the embodiment of FIG. 1, the further file 8 is a plain file. Although only a single plain file is shown in FIG. 1, the Ext3 file system may be stored across a plurality of plain files 8 in the FAT file system.

The data storage device 2 may be inserted into an electronic device and used for data storage by the electronic device. In the embodiment of FIG. 1, the data storage device 2 is intended for use in a navigation device 20.

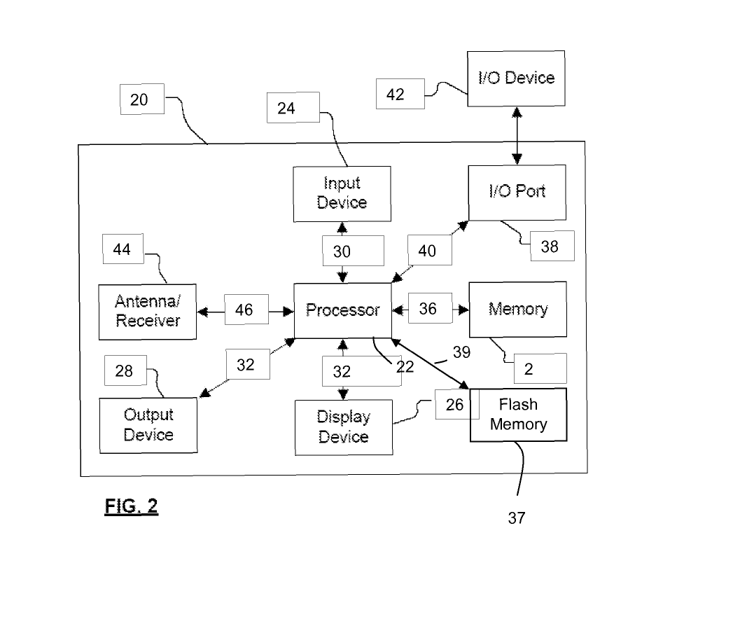

The navigation device 20 is illustrated in FIG. 2, and will be described first, before the interrelation between the FAT file system and the Ext3 file system, the partitioning of data between the file systems and read/write operations to the file systems are described in more detail.

The navigation device 20 is located within a housing (not shown). The housing includes a processor 22 connected to an input device 24 and a display screen 26. The input device 24 can include a keyboard device, voice input device, touch panel and/or any other known input device utilised to input information; and the display screen 26 can include any type of display screen such as an LCD display, for example. In one arrangement the input device 24 and display screen 26 are integrated into an integrated input and display device, including a touchpad or touchscreen input so that a user need only touch a portion of the display screen 26 to select one of a plurality of display choices or to activate one of a plurality of virtual buttons.

The navigation device may include or be connected to an output device 28, for example an audible output device (e.g. a loudspeaker or vehicle radio). As output device 28 can produce audible information for a user of the navigation device 20, it should equally be understood that input device 24 can include a microphone and software for receiving input voice commands as well.

In the navigation device 20, processor 22 is operatively connected to and set to receive input information from input device 24 via a connection 30, and operatively connected to at least one of display screen 26 and output device 28, via output connections 32, to output information thereto. Further, the processor 22 is operably coupled to the data storage device 2 via connection 36 and to an internal Flash memory 37 (in this case a MoviNand device) via connection 39. The processor 22 is further adapted to receive/send information from/to input/output (I/O) ports 38 via connection 40, wherein the I/O port 38 is connectible to a further I/O device 42 external to the navigation device 20. The navigation device 20 also comprises a volatile memory (not shown) such as a Random Access Memory (RAM). The external I/O device 42 may include, but is not limited to an external listening device such as an earpiece for example. The connection to I/O device 42 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 20 and the internet or any other network for example, and/or to establish a connection to a server via the internet or some other network for example.

FIG. 2 further illustrates an operative connection between the processor 22 and a GPS antenna/receiver 44 via connection 46. The antenna/receiver 44 are combined schematically for illustration purposes but may be separately positioned components. The antenna can be, for example, a GPS patch antenna or helical antenna.

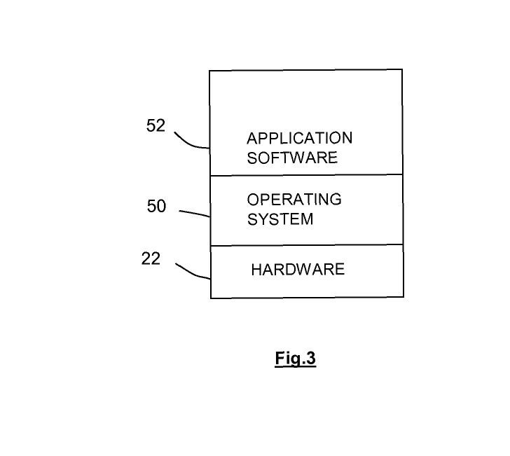

Referring now to FIG. 3 of the accompanying drawings, the internal flash memory 37 stores a boot loader program that is executable by the processor 22 in order to load an operating system 50 from the internal flash memory 37 for execution by functional hardware components, which provides an environment in which application software 52 can run. The operating system 50 serves to control the functional hardware components and resides between the application software 52 and the functional hardware components. The application software 52 is also stored on the flash memory 37 and provides an operational environment including a GUI that supports core functions of the navigation device 20, for example map viewing, route planning, navigation functions and any other functions associated therewith. In variants of the described embodiment, the boot loader program, operating system 50 and/or the application software 52 are stored on the data storage device 2, and in some such variants no internal flash memory 37 is included in the device 20.

When the user switches on the device 20, the device 20 acquires a navigation signal. The location is calculated by a position determining module (not shown) included in the application software 52. The user is then presented with a view in pseudo three dimensions on the display 26 of the local environment in which the navigation device 20 is determined to be located, and in a region of the display 26 below or to the side of the local environment a series of control and status messages. The device 20 provides route planning, mapping and navigation functions to the user, in dependence on user input via a keypad (not shown) or other input device. In variants of the described embodiment, user input provided via a series of interlinked soft or virtual buttons and menu screens that can be displayed on the display 26. The device 20 continues to determine its location on an ongoing basis whilst it is operational.

In the embodiment of FIG. 1, the internal flash memory 37 stores the boot loader and Linux operating system 50 for the navigation device, and also stores the applications that are used by navigation device. Data that is used by those applications, including map data, may be stored on the data storage device 2. The operating system and applications are installed in the volatile memory of the device upon start-up.

An initial set of data, including the bootloader, a Linux operating system kernel, file system and other components, is stored on the internal flash memory 37 during a production or packaging process and is referred to as the factory image.

The largest files stored in the data storage device are usually the map files, and such map files may exceed 1 GB in size. If the navigation device 20 includes a text-to-speech engine, there may also be large voice files (up to 512 MB each) stored in the data storage device 2. Amendments may be made by the user to map features either by amending the corresponding map file or by storing data in an additional amendment file.

As data storage devices (for example SD cards) usually come in discrete sizes, there is usually space left for the user to store additional data. The user may use that space to store, for example, an additional map (e.g. Eastern Europe), a bigger map (new features or more countries), map overlays, or music and photos.

In the embodiment of FIG. 1, all data files that may be used by the navigation device 20 are stored in the Ext3 partition, and no data files used by the navigation device are stored in the FAT partition. It is a feature of the embodiment of FIG. 1 that data in the Ext3 file system can be accessed without having to pass through a FAT file system interface, despite the fact that the Ext3 file system is embedded within the FAT file system, as discussed in more detail below. In turn that enables certain functions of the Ext3 file system, for example journaling and power-fail-safeness, to operate correctly, despite the embedding within the FAT file system. Therefore, in certain embodiments the navigation device 20 does not need to include a FAT file system interface, and may include a limited amount of FAT functionality.

In an alternative embodiment, read only data files, such as maps or voice files are placed in the FAT partition. Files that are writeable by the application software of the navigation device are placed on the Ext3 partition. Examples of such files include configuration files and patch files that contain amendments or additional data relating to map files.

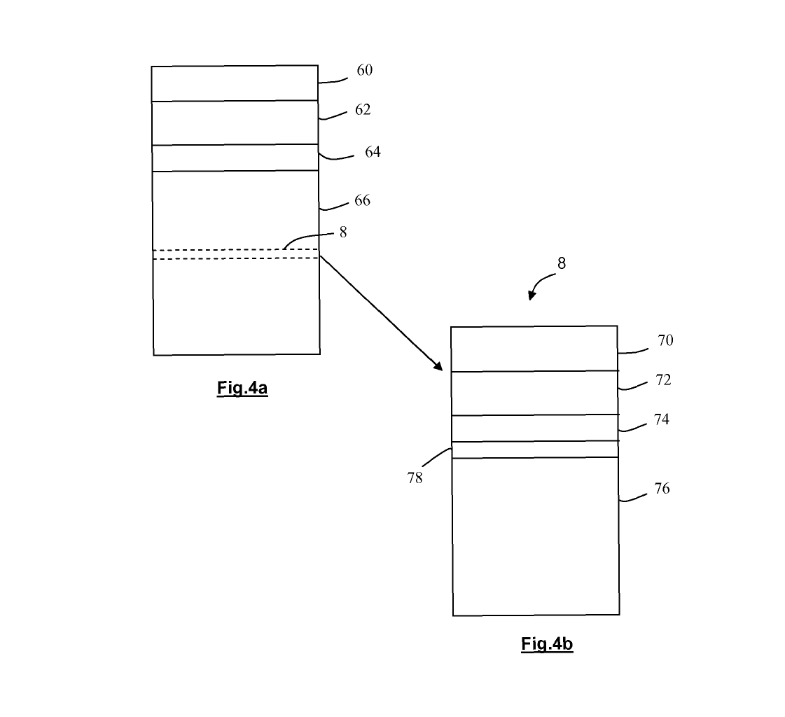

FIG. 4a illustrates schematically the data structure of the data storage device 2. The data storage device 2 is formatted in accordance with the FAT file system and comprises a boot area 60, a file allocation table 62, a root directory 64, and a data area 66.

The boot area 60 comprises basic information concerning the file system, for example cluster and sector sizes, and the size and location of the file allocation table 62 and the root directory 64. The file allocation table 62 comprises entries identifying and locating the physical clusters in the data area corresponding to each stored file, and identifying any free clusters. Physical clusters may also be referred to, interchangeably, as physical blocks. The root directory 64 stores metadata representative of various properties of each stored file, for example a file name, extension, one or more attributes (for example whether a file is read-only) and time stamps representative of time of creation and/or modification. The data area 66 is where the data included in the files is actually stored.

One of the files stored in the data area 66 is the plain file 8 shown in FIG. 1. As mentioned above, the plain file comprises an Ext3 file system, which in turn comprises a plurality of data and/or other files 10. The structure of the plain file is illustrated schematically in FIG. 4b. Only a single plain file is shown by way of illustration, however the Ext3 file system may span more than one plain file. For example, as the maximum file size in the FAT file system is 4 GB, if the Ext3 file system is larger than 4 GB then more than one plain file will be used.

The Ext3 file system included in the plain file 8 comprises a boot area 70, an inode area 72, a directory area 74, and a data area 76. The Ext 3 file system in this example comprises 15,000 blocks each of size 1 KB (providing a total of 15 MB, in two groups).

The boot area 70 contains basic information concerning the Ext3 file system, for example cluster and sector sizes, and the size and location of the inode area 72 and the directory area 74. The inode area 72 contains metadata in the form of inodes representative of properties of the files stored in the Ext3 file system, for example, file type, file size, one or more attributes (for example whether a file is read-only, or access privileges), and time stamps representative of time of creation and/or modification, if required, as well as the identity and location of the clusters in the data area 76 containing the file data. Each inode is 128 bytes in size, and extended attributes are not used. The directory area 74 contain file names and associated inode identifiers, identifying the inode or inodes associated with each file name. The data area 76 contain the file data.

The Ext3 file system also includes a journal 78, which is used to journal data and/or metadata during the writing of data and metadata by the file system. The journal is 1 MB in size (1024 blocks) in the example of FIG. 1.

The data structures of FIGS. 4a and 4b represent different areas of the file systems, and different files, as contiguous structures, and can be considered to represent the logical structures of the file systems. Data is physically stored on the data storage device 2 in physical storage elements, for example fixed size clusters or blocks. Usually, each file is stored in a set of non-contiguous physical blocks selected from the physical blocks that were free at the time the data was stored.

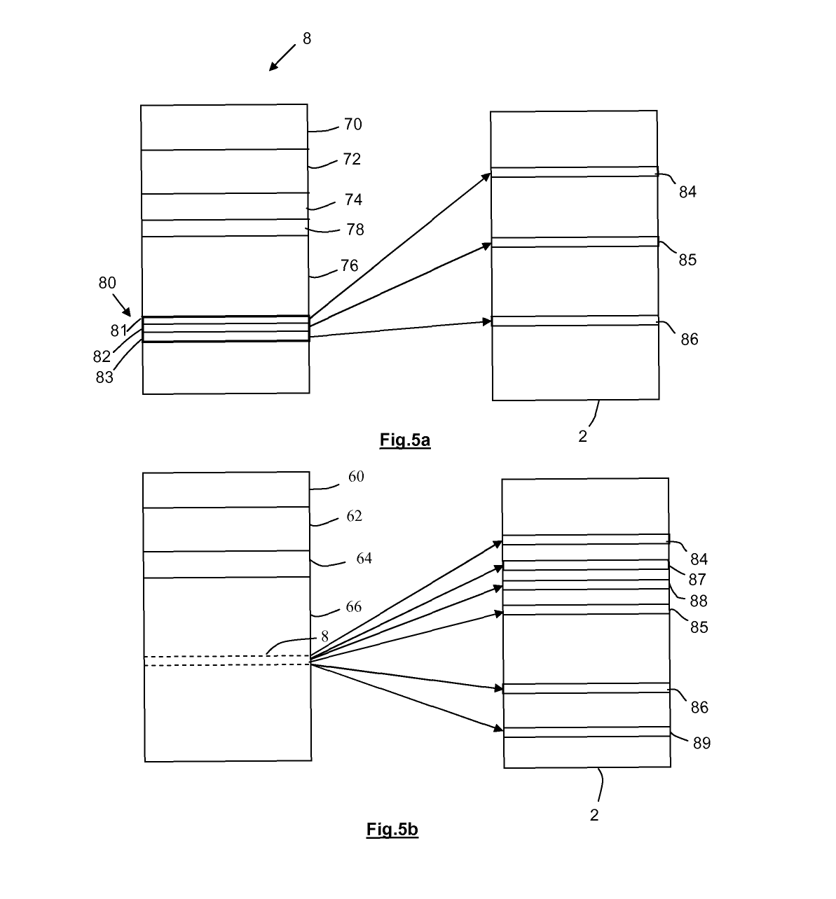

Each file in the Ext3 (or FAT) file system can be considered to be made up of one or more logical elements, for example blocks, containing data and/or metadata, each of fixed size. An example of a file 80 stored in the data area 76 of the Ext3 file system is illustrated in FIG. 5a. It can be seen that the file 80 comprises data in three equal-sized logical blocks. The data of the logical blocks is stored in three non-contiguous physical blocks 84, 85, 86 on the data storage device 2.

The file 80 forms part of the plain file 8 in the FAT file system, and as illustrated in FIG. 5b, the plain file 8 is stored as a plurality of non-contiguous physical blocks that include the physical blocks 84, 85, 86 of the file 80 illustrated in FIG. 5a and additional physical blocks 87, 88, 89 that contain data and metadata for other files of the Ext3 file system. Only three additional physical blocks 87, 88, 89 are shown in FIG. 5b by way of illustration, but in practice the plain file 8 containing the Ext3 file system is stored across thousands of physical blocks on the data storage device 2.

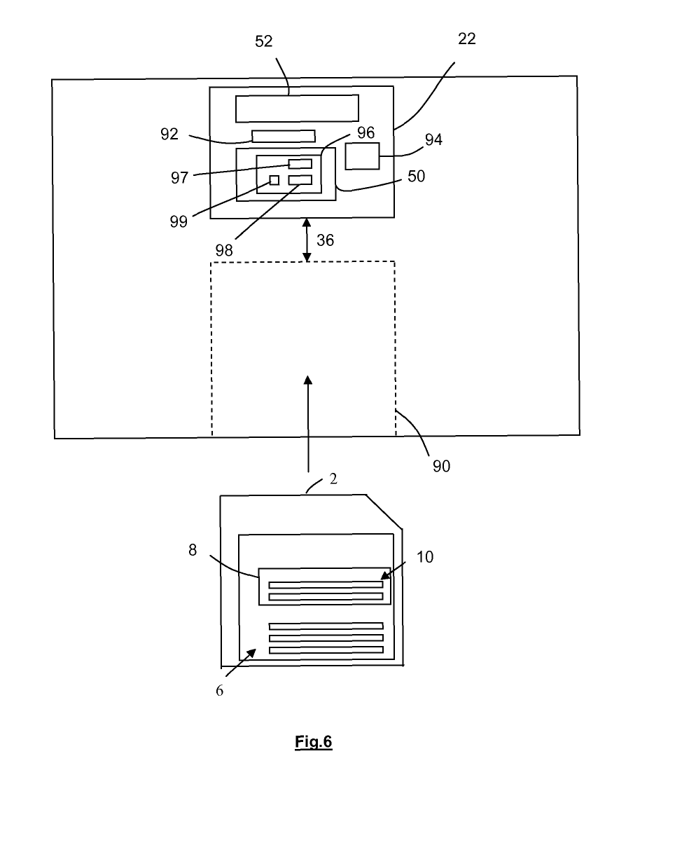

File system operations that may be performed by the navigation device 20 on the file systems of the data storage device 2 will be described in more detail in relation to FIG. 6.

FIG. 6 shows schematically the navigation device 20, the processor 22 and a slot 90 in the navigation device 20 for removable installation of the data storage device 2. In operation, the operating system 50 and the application software 52 are installed and operated at the processor 22. A file system controller 92 and a file system mapping device 94 are also installed and operated at the processor 22. The operating system comprises an Ext3 file system interface 96 for performing operations on the Ext3 file system. The Ext3 file system interface 96 comprises a page cache 97, and a device driver 98 for performing operations on the data storage device 2, for example reading data from or writing data to physical blocks of the data storage device 2. The Ext3 file system interface also includes a translation module 99.

As mentioned above, it is a feature of the embodiment of FIG. 1 that the data in the Ext3 file system can be accessed without having to pass through a FAT file system interface, despite the fact that the Ext3 file system is embedded within the FAT file system.

Although the operating system 50 does not include a FAT file system interface in the embodiment of FIG. 6, the file system mapping device 94 does include a limited number of FAT file system components, sufficient to read the FAT file system. The FAT file system components that are included are able to read file allocation tables and (short) file names from FAT directories, and are able to determine which physical blocks are used to store the at least one plain file, and in which order. The FAT file system components that are included do not comprise a driver, and they do not provide file system services to other parts of the system apart from producing identification data identifying physical storage elements, for example in the form of the indirection table described below. The file system mapping device 94 forms part of the boot loader of the system or is a user space component that runs from a small RAM disk included in the device 2. The name of the plain file or sequence of plain files 8 that store the Ext3 file system are included in the boot script. At device boot time, the file system mapping device 94 inspects the FAT file system, identifies the location of the plain file or sequence of plain files 8 and builds an indirection table for the plain file 8, or sequence of plain files, in the FAT file system that make up the Ext3 file system. This indirection table is an injective mapping between ranges of logical blocks and actual ranges of storage blocks, and thus can be used to provide a mapping for each block in the device Ext3 file system.

TABLE 1

| Logical block | Logical block | Offset to physical |
|---|---|---|
| range start | range end | blocks |
| 0 | 999 | 750 |
| 1000 | 1199 | −650 |

An example of an indirection table is provided in Table 1. In this case it can be seen that for logical blocks from 0 to 999 an offset of 750 is applied to map the logical blocks to physical blocks of the storage device 2. Thus the data of logical blocks 0 to 999 is stored at physical blocks 750 to 1749. Similarly, an offset of −650 is applied to logical blocks 1000 to 1199, and the data of logical blocks 1000 to 1199 is stored at physical blocks 350 to 549.

After compiling the indirection table, the file system mapping device 94 installs the indirection table in the device driver 98, or stores it elsewhere in volatile or non-volatile memory. In one mode of operation the device driver identifies to any layers of the system above the device driver the logical blocks of the indirection table as being the blocks that are present on the data storage device. Thus, as far as those layers are concerned, the data storage device comprises a contiguous range of physical storage blocks (0 to 1199 in the example of Table 1). The translation module 99 forming part of the file system interface 96 is used to translate every access to the device's Ext3 file system into the correct physical location on the data storage device using the indirection table. The translation module 99 can be included within the device driver 98 in some embodiments. The file system mapping device 94 is only needed on system boot in order to generate the indirection table, and can then be discarded.

The upper layers of the system (for example, all components of the system above the driver, in one mode of operation) may have no awareness of the fact that the block device driver 98 uses indirection mapping, which allows the device Ext3 file system to be mounted as a root file system and to be booted from. As the Ext3 file system can be mounted as a root file system by the Linux operating system 50, the keeping of parts of the root file system in RAM can be avoided.

It is a feature of the indirection mapping that the mapping table effectively masks out FAT file system ranges that contain FAT metadata (these are simply not mapped at all by the mapping table). Therefore, FAT file system corruption is unlikely to occur during file system operations on the Ext3 file system. As the FAT file system metadata is not touched, the FAT file system can be mounted read only by the navigation device (in variants in which a FAT file system interface is provided) if at all.

In operation, the system is able to perform read or write or other operations on files in the Ext3 file system without having to pass through a FAT file system interface, by using the indirection table to identify the location of physical blocks that are to be read or written.

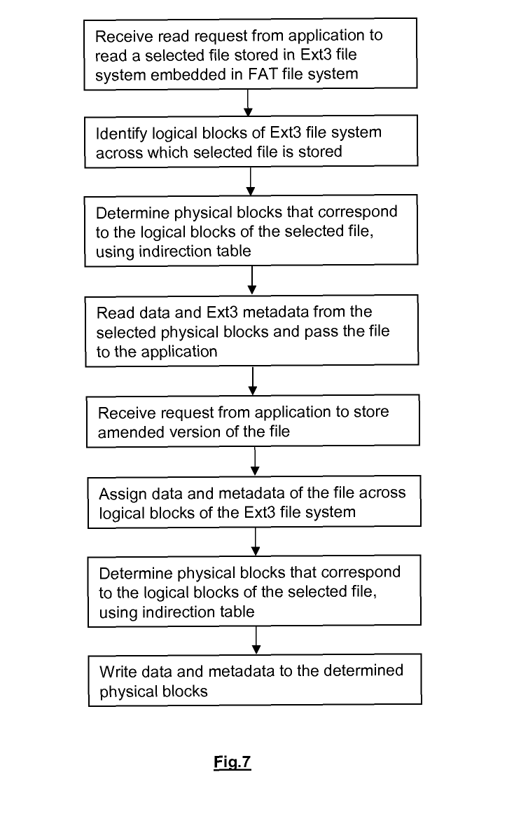

In one example, considered in overview and illustrated in the flowchart of FIG. 7, if an application wishes to open and amend a file, it sends a request to the Ext3 file system interface 96, which identifies and selects the logical blocks across which the file is stored, and sends a request to the device driver 98 to read the data from the corresponding blocks in the data storage device 2. The translation module included in the device driver 98 determines the physical blocks that correspond to the selected logical blocks of the Ext3 file system using the indirection table, and the device driver 98 then reads the data from those physical blocks of the data storage device 2 and passes the data back to the Ext3 file system interface 96, which then passes the data back to the application.

The application in this example amends the data and then sends the data back to the Ext3 file system interface, which assigns the data across the identified logical blocks, writes the logical blocks to a page cache and instructs the device driver 98 to write the logical blocks to the data storage device 2. The translation module included in the device driver 98 again determines the physical blocks that correspond to the selected logical blocks of the Ext3 file system using the indirection table, and then writes the data to the data storage device 2 by copying the data from each logical block stored in the page cache to its corresponding physical block on the data storage device 2.

The example described in the preceding two paragraphs is simplified in that it does not take describe journaling operations that are performed by the Ext3 file system. In practice, each block that is written, forming part of a transaction, is firstly written to the journal 78 on the data storage device 2 before being written to its final destination.

Once data has been successfully written to its final destination, it can subsequently be deleted or overwritten from the journal. If there is a failure to write to the final destination then the complete transaction is present in the journal and can be recovered by replaying the journal. If there is a failure during the writing to the journal then the journal entry is not complete and is ignored. The Ext3 journal is typically of limited size and so large data writes are usually broken up into small transactions. The journal entry for each write operation includes metadata that represents the status of the write operation.

The writing of transactions to the journal and to the final destination must pass through the page cache, before input and output operations (block I/O) operations are performed at the hardware/device level by the device driver 98. The Ext3 file system has ordering constraints for at least some journal operations, in particular the writing of metadata to the journal. For example, the flag that indicates a transaction is complete should be written before the complete transaction is written to disk. The Ext3 file system interface 96 determines when and which pages are written back, and ensures that pages are written back in the correct order to maintain proper operation of the Ext3 journaling by use of hooks in the page cache.

The device driver 98 in the embodiment of FIG. 6 does not affect the ordering of page writes from the page cache to the physical data storage device 2, and page writes pass from the page cache to the data storage device 2 via the device driver 98, without passing through a FAT file system interface or FAT page cache. Therefore, the embodiment of FIG. 6 is able to maintain the same ordering of write operations as determined by the Ext3 file system interface 96. In turn that means that the embodiment of FIG. 6 is able to maintain correct operation of the Ext3 journal and power-fail-safe writing of data.

In contrast, if an Ext3 file system were to be included as a loopback device in a FAT file system the ordering of physical writes may be determined by the FAT file system rather than by the Ext3 file system. For example, in that arrangement a writeback daemon (pdflush) may determine what pages to write back from the cache to the data storage device without ordering constraints. Typically the writeback daemon would write back pages to a device in dependence on the physical proximity of the physical blocks or clusters in which they are to be stored at the device, and not in transaction order, which would make the system potentially not power fail safe. For example, there would be a significant power fail hazard if a transaction complete flag were to be written to the data storage device before the corresponding complete transaction were to be written to the journal on the data storage device. In that case, if there was a power fail after the transaction complete flag had been written but before the complete transaction was written, the journal replay process would conclude that the transaction had been validly written to the data storage device when it had not.

The embodiment of FIG. 6 can allow operations to be performed on files or individual blocks of the Ext3 file system without having to open the entire plain file 8 in the FAT file system, without having to modify FAT metadata associated with the FAT file system, and without duplication of writes to the page cache.

In the embodiment described above in relation to FIG. 6, all data files that may be used by the navigation device 20 are stored in the Ext3 partition, and no data files used by the navigation device are stored in the FAT partition. In a variant of the embodiment of FIG. 6, read only data files, such as maps or voice files are placed in the FAT partition. Files that are writeable by the application software of the navigation device are placed on the Ext3 partition.

In that variant, the operating system includes a FAT file system interface as well as an Ext3 file system interface. The file system controller 92 is configured to determine whether to direct read operations to the FAT or Ext3 file systems, and is also configured to direct all write operations to the data storage device 2 by the navigation device 20 to the Ext3 file system. Operations, such as read or write operations, are performed on the Ext3 file system as described above in relation to FIG. 6, and thus correct journal operation and power-fail-safeness can be maintained. The read operations on the FAT file system are performed in accordance with standard FAT operation via the FAT file system interface.

The file system controller 92 is in operative communication with both the application software 52 and, via the FAT and Ext3 file system interfaces, with the FAT and Ext3 file systems on the data storage device. The file system controller 92 is operable to mount the file systems on the data storage device and to provide a combined view of the file systems for the application software 52. The file system controller 92 is also operable to manage requests for reading and writing of data to the file systems of the data storage device 2, and other file system operations, and to partition data between the file systems.

In a further variant, files are written to either the FAT partition or the Ext3 partition in dependence on one or more predetermined criteria applied by the file system controller 92. In some such variants, FAT file system functions included in the operating system exclude functions that support long file names in the FAT file system. The files in the FAT partition are usually specified to have only short names. If a directory has a long file name then all files in that directory (even if they have short file names) are included in the Ext3 file system, as the FAT file system cannot contain the higher level directory name without long filename support. Files written to the data storage device 2 are directed to the Ext3 file system rather than the FAT file system by the file system controller 92, and so long file system functionality can be provided to the user despite an absence of long file name components in the FAT file system.

In an alternative variant, the FAT file system functions included in the operating system include functions that support long file names. In that case, the factory image still includes only short file names in the FAT file system, and the file system controller 92 stores files to the Ext3 file system rather than the FAT file system. However, the FAT long file system functions can be useful if the data storage device 2 is accessible by external, third party applications or devices.

For example, in some embodiments the data storage device 2 may be connected to another computer via a USB connection, and accessed by standard music or other media software. Such other applications or devices may have access only to FAT drivers, and in those circumstances files (for example music or image files, such as MP3 or JPEG files) added by those other applications or software may be written to the FAT partition, and it may be desirable to support long file names. The writing of files by such other applications or devices is non-power fail safe.

In another embodiment or mode of operation, the file system controller 92 is configured to write files to either the FAT partition or the Ext3 partition in dependence on the length of the file name. For example, the file system controller 92 may be configured to write all files that have a file name longer than the 8.3 format to the Ext3 partition.

The description above concerning the embodiment of FIG. 6, and variants or alternatives to the embodiment, relates to read, write or other file system operations performed by the navigation device 20 in response to requests from application software 52 at the navigation device 20. The system can also include software and/or a file system controller on a personal computer, which can also perform file system operations on the data storage device 2.

The electronic device 20 can be connected to a personal computer 100, for example via a USB connection, and communication between the personal computer 100 and the data storage device 2 can be via the electronic device. Alternatively, the data storage device 2 can be connected to the personal computer 100 via a card reader device, for example a USB card reader.

A connection via a USB cable between the data storage device 2 and a personal computer 100 including application software 102 and a file system controller 104 is illustrated in FIG. 7. Communication between the storage device 2 and the personal computer 100 is established using standard techniques.

The personal computer 100 includes a standard operating system 106 (for example, MS Windows or Mac OS X) that includes a FAT files system interface and driver 108 in its kernel. The application software 102 includes an application logic layer 110 that comprises various modules providing application functions. The application software 102 is able to perform various functions relating to the navigation device 20, including viewing maps and planning routes, updating map and other data, and downloading and analysing or forwarding usage data from the navigation device 20.

When the navigation device 20 is connected to the personal computer 100, at least some of the functionality of the navigation device 20 is suspended and, for example, route planning, mapping and navigation functions are not available to the user via the navigation device. The user may instead perform functions relating to the navigation device 20 via the functionality provided by the application software 102 running on the personal computer 100. A user may add new data or update, amend or delete data existing stored on the data storage device 2 of the navigation device 20.

The FAT driver 108 included in the operating system 106 of the personal computer can be used to control read, write and other file system operations of the

FAT file system on the data storage device 2. The operating system does not include drivers for the Ext-3 file system, and Ext2/3 drivers are instead provided by the file system controller 104 included in the application software. The file system controller 104 controls reads and writes to the Ext-3 file system. As the Ext3 file system is stored within a plain file or files, special operating system privileges are not required in order to modify data within the Ext3 file system.

In the embodiment of FIG. 9, journaling of data writes to the Ext3 file system by the personal computer 100 is not used. As journaling is not used, the file system controller 104 can treat the Ext3 file system of the data storage device 2 as an Ext2 file system for the purposes of read and write operations. The Ext2 file system is substantially the same as the Ext3 file system, but does not provide journaling capabilities. If the journal of an Ext3 file system is empty it can safely be mounted as an Ext2 file system. Before doing so however, the file system controller 104 confirms that the Ext3 file system on the data storage device 2 has previously been dismounted correctly, and there are no outstanding incompatibilities between journal and data entries. It does so by reading the appropriate flag in a superblock of the Ext3 file system. If the file system controller 104 determines from the flag that the file system has not been dismounted correctly, it performs a file system check using the e2fsck function, and recovers any outstanding journal entries before mounting the file system as an Ext2 file system.

In alternative embodiments, the data storage device 2 is permanently installed in the navigation device 20 rather than being a removable memory device, such as an SD card.

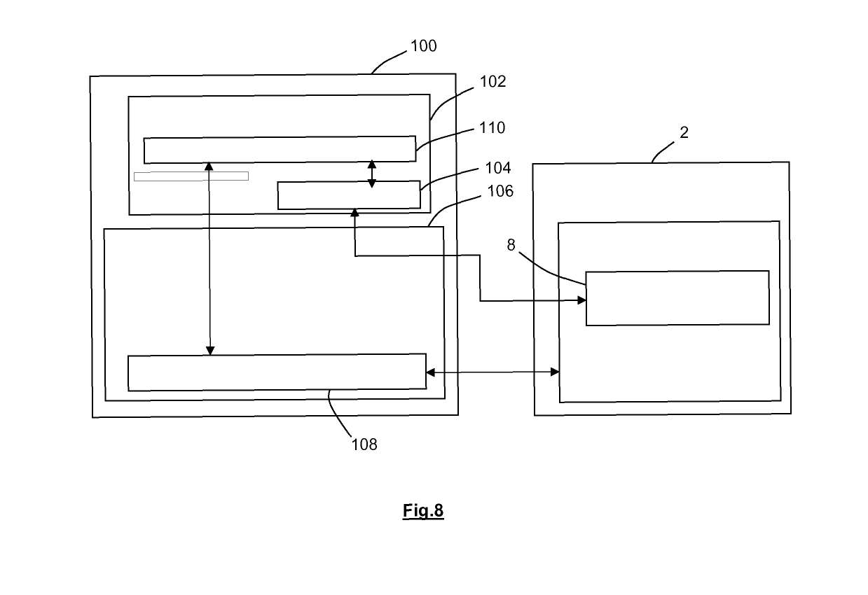

The embodiments described in relation to FIGS. 1 to 8 relate to a data storage system for a navigation device. However, the invention is not limited to data storage systems for navigation devices and in alternative embodiments data storage systems are used with other electronic devices, or with a personal or other computer. Examples of electronic devices with which the data storage system is used, or within which the data storage system is installed, in other embodiments include, but are not limited to, for example, MP3 players or other music players, digital cameras, video cameras, personal digital assistants (PDAs), mobile phones laptop or handheld computers and any kind of embedded device or processor. The data storage system may comprise any type of data storage device including, but not limited to, for example, a hard disk, a flash memory device, a CD, a DVD or any other type of magnetic, optical or other storage device.

The embodiments described in relation to FIGS. 1 to 8 each include a data storage device that includes both a FAT file system and an Ext3 file system in one or more plain files in the FAT file system. The FAT file system may be any of a an FAT, vFAT, FAT16, or FAT32 file system. However, the invention is not limited to the combination of FAT and Ext3 file systems, and in other embodiments different combinations of file systems are provided. By providing for at least two different types of file system, it can be ensured that the most appropriate file system can be used for different operations or data, whilst at the same time ensuring compatibility with existing devices or operating systems. For example different combinations of power-fail-safe and non-power-fail-safe file systems and/or different combinations of file systems that have different long-file-name functionality are provided in alternative embodiments.

In other embodiments, other data storage systems are provided within the at least one file (for example at least one plain file) of the FAT or other file system, instead of a further file system. For example, database entries or a pagefile can be provided within the at least one file. A mapping device identifies the physical storage elements that correspond to the at least one file, and stores identification data (for example a table) that identifies those physical storage elements. The identification data can then be used subsequently to access the content of the at least one file (for example, the database entries or the pagefile) without having to read the FAT or other metadata, or for example without requiring a FAT file system driver.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

The file system mapping device, the translation module, and the file system interfaces may be implemented as combinations of software elements or modules, or may be implemented as sub-modules or components of a single software programme, alternatively they may be implemented as any suitable combination of hardware and software.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst embodiments described herein implement certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It will be understood that the present invention has been described above purely by way of example, and modifications of detail can be made within the scope of the invention.

Each feature disclosed in the description, and (where appropriate) the claims and drawings may be provided independently or in any appropriate combination. Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A data storage system comprising:
a data storage device that stores a file system, wherein the file system comprises metadata that maps file identifiers of files in the file system to physical storage elements that store the files;
file system mapping means for reading the metadata of the file system to determine physical storage elements that store a predetermined at least one file of the file system, and storing identification data that identifies the determined physical storage elements; and
means for at least one of reading or writing that is configured in operation to read the stored identification data and at least one of read from or write to physical storage elements identified by the identification data.

2. A system according to claim 1, wherein the predetermined at least one file comprises at least one plain file.

3. A system according to claim 1, wherein the physical storage elements identified by the identification data exclude substantially all elements that include metadata of the file system.

4. A system according to claim 1, wherein the file system is a first file system of a first type, and the predetermined at least one file comprises a second file system of a second, different type.

5. A system according to claim 4, wherein the identification data comprises a mapping between logical elements of the second file system and corresponding physical storage elements.

6. (canceled)

7. A system according to claim 5, wherein the reading and/or writing means comprises a file system interface for the second file system, operable to receive a request to perform an operation on a selected file of the second file system, to identify at least one logical element of the selected file, to determine the at least one physical storage element that corresponds to the identified at least one logical element using the mapping, and to perform the operation on the determined, corresponding at least one physical storage element.

8. A system according to claim 7, wherein the operation comprises a write operation or a read operation, and the file system interface is operable to perform the write operation or the read operation on the determined, corresponding at least one physical storage element of the selected file without performing a read or write operation on at least one physical storage element of at least one other file of the second file system.

9. A system according to claim 7, wherein the system comprises a file system interface for the first file system, and the file system interface for the second file system is arranged to perform the operation on the at least one physical storage element independently of the file system interface for the first file system.

10. A system according to claim 7, wherein the file system interface for the second file system is arranged to perform the operation without opening the at least one file of the first file system that comprises the second file system.

11. A system according to claim 7, wherein the performance of the operation on the determined, corresponding at least one physical storage element of the data storage device comprises substantially no alteration to first file system metadata.

12. A system according to claim 7, wherein the performance of the operation by the file system interface comprises writing a succession of logical elements to corresponding physical storage elements, and the file system interface is configured to write at least some of the succession of logical elements to corresponding physical storage elements in a desired order.

13. A system according to claim 7, wherein the performance of the operation comprises writing the succession of logical elements to a cache, and writing the logical elements from the cache to the corresponding physical storage elements, and the file system interface is configured to write at least some of the logical elements from the cache to the corresponding physical storage elements in the same, desired order as they were written to the cache.

14. A system according to claim 12, wherein the logical elements that are written in a desired order comprise journal data or journal metadata.

15. A system according to claim 4, wherein the selected file comprises a boot file, and the operation comprises reading the boot file from the second file system.

16. A system according to claim 4, wherein the first file system comprises a non-power-fail-safe file system and the second file system comprises a power-fail-safe file system.

17. A system according to claim 4, wherein the second file system comprises a journaled or a transactional file system and the first file system comprises a non-journaled or non-transactional file system.

18. A system according to claim 4, further comprising a file system controller for directing file system operations to one or other of the first and second file systems.

19. A system according to claim 18, wherein the file system controller is arranged to receive requests to write files to the first or second file systems, and to write to the second file system in response to substantially all requests to write files that have at least one predetermined file name property to the first or second file system.

20. A system according to claim 19, wherein the at least one predetermined file name property comprises the property that the file name is not supported by the first file system.

21. A system according to claim 19, wherein the at least one predetermined file name property comprises the property that the file name is longer than a predetermined file name length limit.

22. A system according to claim 18, wherein the file system controller is configured to write to the second file system in response to substantially all requests received by the file system controller for write operations to the first or second file systems.

23. A system according to claim 4, wherein the first file system comprises a FAT-based file system and the second file system comprises an EXT file system.

24-26. (canceled)

27. A method of reading and/or writing data comprising reading metadata of a file system that is stored on a data storage device to determine physical storage elements of the data storage device that store a predetermined at least one file of the file system, storing identification data that identifies the determined physical storage elements, reading the stored identification data and reading and/or writing data to physical storage elements identified by the identification data.

28. (canceled)

29. A computer program product comprising computer executable instructions for providing file system mapping means for reading metadata of a file system that is stored on a data storage device to determine physical storage elements of the data storage device that store a predetermined at least one file of the file system, and storing identification data that identifies the determined physical storage elements.
